(19) United States
(12) Patent Application Publication
(10) Pub. No.: US 2011/0075801 A1
(43) Pub. Date: Mar. 31, 2011

(54) Process and Apparatus for Identifying Autocatalysts

(76) Inventors: Christian Hagelüken, Hanau (DE); Liesbet Jongen, Waechtersbach (DE); Thorsten Rieke, Rodenbach (DE); Thomas Klümper, Hofheim im Taunus (DE)

(21) Appl. No.: 12/872,478

(22) Filed: Aug. 31, 2010

(30) Foreign Application Priority Data
Sep. 5, 2009 (EP) 09011402.6

(51) Int. Cl. G01N 23/06

(52) U.S. Cl. 378/53

(57) ABSTRACT

The present invention relates to a process and apparatus for non-destructive identification of encased autocatalysts which comprise metallic and/or ceramic support substrates which may possess a catalytic coating. The process comprises the X-raying of the encased autocatalysts and the identification of the autocatalyst by comparing the data obtained with a data bank which contains information about industrially manufactured autocatalysts. Optionally, the process may comprise further examination steps (for example weighing, measurement of the electrical and/or magnetic properties or photographic imaging).

The process and apparatus find use for non-destructive, exact and rapid recognition or identification of encased autocatalysts and particulate filters.

The present invention relates to a process and to an apparatus for non-destructive recognition and identification of autocatalysts, especially of spent encased automotive exhaust gas catalytic converters and particulate filters. The process can be used in the purchasing, sorting and processing of autocatalysts, and enables rapid information about the material properties, the condition and the value of spent used catalytic converters or particulate filters.

Noble metal-containing catalytic converters, for example automotive exhaust gas catalytic converters and emission control catalysts from industrial plants, are being obtained in increasing amounts as waste material. The greatest portion thereof is catalytic converters from deregistered and scrapped motor vehicles, almost all of which in Germany nowadays have already been fitted with a catalytic converter. In Western Europe, more than 5 million catalytic converters per year from used motor vehicles are expected by 2010. Considerable amounts of the noble metals platinum, palladium and rhodium are bound within these catalytic converters, and the recycling thereof is of great economic and ecological significance.

An autocatalyst consists of a metallic and/or ceramic support substrate, the surface of which has generally been provided with a catalytically active coating (“washcoat”), which comprises the noble metals platinum (Pt), palladium (Pd), rhodium (Rh) and, in special cases, iridium (Ir) in different combinations. The coated ceramic support substrate (“monolith”) is encased with a mineral fibre mat (known as an intumescent mat) and/or a wire mesh, and incorporated into a steel casing, which in turn is part of the exhaust gas system of a motor vehicle. In the case of metallic catalysts, the coated catalyst foil is soldered directly to the steel casing. Such encased autocatalysts are referred to in the present invention as encased used catalytic converters. In addition, what are known as particulate filters (especially soot particulate filters) have recently started to be used in diesel vehicles in particular, and generally have a ceramic support substrate which may be either noble metal-coated or uncoated. In the present application, the term “autocatalyst” encompasses automotive exhaust gas catalytic converters and particulate filters, NOx storage catalysts as well as SCR catalysts.

In the recycling chain for catalytic converters, the following structures have developed: an automobile recycler sells used catalytic converters by unit (“tel quel”) to a purchaser. The purchaser collects used catalytic converters and sells them to a catalytic converter dismantling company. The catalytic converter dismantling company (“dismantler”) separates the noble metal-containing catalyst support from the steel casing, generally with hydraulic shears, and collects the ceramic up to amounts of 1000 kg or higher. The dismantler supplies the noble metal-containing catalyst ceramic to a noble metal refinery, in which the material is comminuted or ground, homogenized and representatively sampled, and then the noble metals are recovered. On the basis of the noble metal contents analysed from the sample, the account is settled between the dismantling company and the noble metal refinery.

Since the early 1990s, there has been a considerable increase in the variety of catalytic converter types in Europe; these catalysts are now increasingly arriving in the recycling cycles, and will continue to do so in the years to come. In the catalytic converters for gasoline engines, the traditional Pt:Rh ratio of 5:1 with 1.5 g/l noble metal content has been replaced by catalyst coatings which, as well as platinum and rhodium, also contain palladium (Pd), sometimes in dominant amounts. Diesel vehicles too are increasingly being equipped with catalytic converters. However, these generally comprise only platinum and palladium. Overall, both the ratio of Pt, Pd and Rh to one another and the noble metal loading in autocatalysts have varied since then within a very wide range. Since the variations in the noble metal contents also occur within one type of car, even the person skilled in the art can no longer visually discern the approximate noble metal content of the autocatalyst and what the corresponding purchase price should be. This constitutes a considerable financial risk for the purchaser. In order to be able to obtain more exact information about the used catalytic converter to be purchased, the catalyst has to be “decanned”. However, this is time-consuming and costly.

WO 2006/015831 discloses an apparatus for mobile pretreatment and analysis of ceramic-based noble metal-containing catalytic converters. This system comprises devices for comminution, for weighing and for analysis of the comminuted ceramic material. The process requires decanning of the catalyst.

EP 605748B1 describes a process and an apparatus for processing of supported metal catalytic converters. However, there is no mention of processes for identifying autocatalysts or for distinguishing between autocatalysts with metallic and ceramic support substrates.

It is therefore an object of the present invention to provide a simple, rapid process which enables the exact recognition and identification of encased (i.e. canned) autocatalysts, including the steel casing. Such a process should proceed without destruction, i.e. not need complicated decanning of the autocatalyst. It should also enable purchasing at true value and material-oriented processing of used catalytic converters. It is a further object of the present invention to provide a suitable apparatus with which the process according to the invention can be implemented.

This object is achieved by the process and the apparatus according to the present claims. The invention is described in detail hereinafter.

The present invention relates to a process for non-destructive identification of an encased autocatalyst which has at least one metallic and/or ceramic support substrate, the surface of which may be provided with a catalytically active coating, comprising the steps of
A X-ray inspection of the encased autocatalyst and collection of data for characterization of the support substrate,
B identification of the autocatalyst by comparing the data obtained with a data bank.

The X-raying in step A is effected with at least one X-ray generator at an anode voltage in the range from 80 to 250 kV, preferably in the range from 100 to 180 kV. The mean residence time for the X-raying is within the range from 0.5 to 10 sec, preferably in the range from 1 to 5 sec.

The data bank used for comparing data in step B preferably encompasses information from already known, industrially manufactured support substrates and/or autocatalysts (“catalyst library”). In the simplest case, data lists are used, and are evaluated manually. The data bank preferably comprises previously stored and catalogued data for identified autocatalysts (e.g. support substrate, motor vehicle model, year of manufacture, motor vehicle manufacturer, part numbers, etc). The evaluation is effected by electronic data processing (computer, PC).

The data obtained in step A are compared with the previously stored and catalogued data for known, industrially manufactured autocatalyst systems (i.e. with a “catalyst library”). A correlation with the values in this data bank enables exact identification of the used catalytic converter present.

The surface of the metallic or ceramic support substrate in many cases has a catalytically active coating which generally comprises at least one noble metal from the group of Pt, Pd, Rh and Ir or combinations thereof. The data for characterization of the support substrate obtained in step A advantageously also comprise information about the presence, type and/or amount of the noble metals from the group of Pt, Pd, Rh and Ir. This enables timely purchase at true value of encased autocatalysts.

Should the data obtained from the X-ray examination (step A) not enable clear, unambiguous identification of the autocatalyst, the process according to the invention can be extended to safeguard the diagnosis, and may comprise further (optional) examination steps in addition to steps A and B. The additional data obtained with such examination steps can be combined with the data from the X-ray examination, thus enabling full characterization/identification of the autocatalyst examined.

For example, the process according to the invention may have, as further examination steps, a measurement of the electrical and/or magnetic properties. Electrical measurements can enable, for example, a distinction between metal and ceramic support substrates. Information about the magnetic properties can be employed to classify the steel type used for the catalyst casing.

There may be an additional integrated weighing step. In addition, the process may also include photographic imaging, which enables the recognition and recording of part numbers, etc.

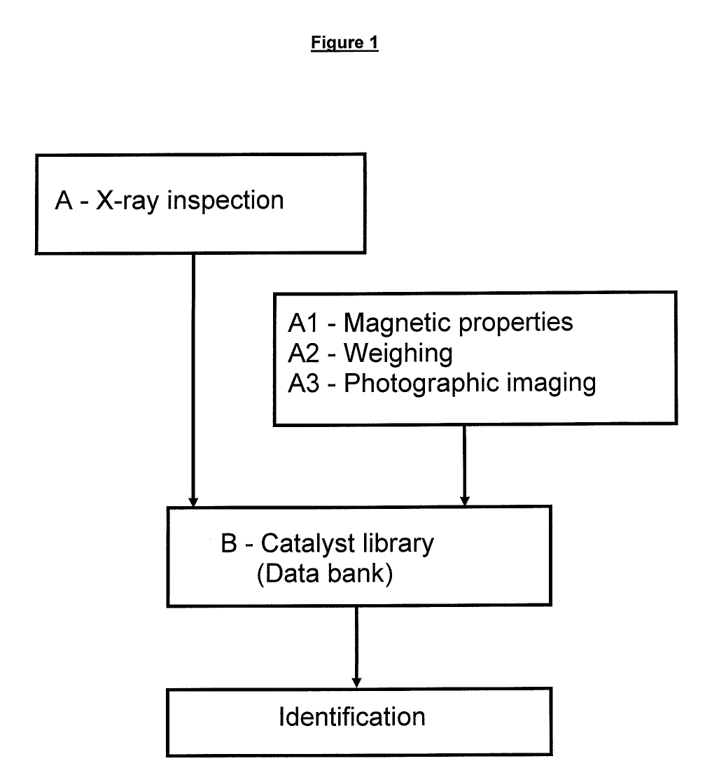

FIG. 1 shows a schematic diagram of a possible embodiment of the process according to the invention, in which, in addition to X-raying (step A), the examination steps of measuring the magnetic properties (step A1), weighing (A2) and photographic imaging (step A3) are carried out. In the simplest embodiment, the process, however, comprises only steps A and B; according to the application, the desired accuracy and the data, any desired further combinations of such additional examination steps are possible. The additional examination steps A1-AX can be performed in parallel or in succession (i.e. sequentially); the results or data obtained therefrom are combined in step B with the data bank (catalyst library), and evaluated in order ultimately to obtain the most exact identification possible of the autocatalyst and, if appropriate, to identify forgeries. Optionally, it is possible to integrate further examination steps into the process according to the invention if they are needed for more exact identification of the autocatalyst to be examined.

X-raying equipment or X-ray inspection equipment is known from non-destructive material testing, from product inspection and from airport security checks. The method of X-ray inspection is based in principle on the absorption of X-radiation by the material. In this process, an X-ray source radiates through a test specimen. According to the density and thickness of the material, the radiation is attenuated to a greater or lesser degree and converted to a corresponding greyscale image with an X-ray sensor on the opposite side. This gives an image representation, since different materials exhibit different absorption behaviour. If differences in concentration are present for a given material, this can be recognized with an image representation. The more X-radiation is absorbed, the darker the image becomes. With the repetition of the operation from different angles, it is also possible to conduct a three-dimensional reconstruction of the object (3D imaging).

The use of X-ray inspection for examination of encased used catalytic converters (i.e. complete converters including the steel casing) has not been described to date. The absorption of X-radiation is element- and concentration-dependent, and so the X-radiation is absorbed more strongly by heavier elements. For example, platinum absorbs more X-radiation than palladium; the method thus allows a qualitative distinction between these two noble metals. The higher the concentration of a metal or noble metal, the higher is the X-ray absorption. As a result, it is possible, for example, to recognize gradients in the noble metal coating of a support substrate.

It has been found that it is possible with suitable X-ray inspection units to exactly characterize the support substrates (ceramic monoliths and/or metallic supports) in the interior of an encased autocatalyst. It is thus possible to obtain data about the condition, form, dimensions, structure and coating of these support substrates, without any need to perform decanning beforehand.

In addition, it is possible with the aid of X-ray inspection to perform qualitative element recognition. With the aid of specific X-ray detectors tailored to the absorption spectrum of a specific element (for example Pt), it is possible to make a statement about the particular noble metal composition of an autocatalyst. In the present case, this means that a qualitative recognition of the noble metals present in the catalyst coating, platinum, rhodium and palladium, can be carried out. Especially the presence or absence of rhodium constitutes important information for assessment of the price of an autocatalyst. The X-ray inspection equipment for the process according to the invention may optionally be equipped with X-ray detectors and optionally filters for the noble metals Pt, Rh and Pd.

The X-radiation used is generally obtained by electrical means and can be switched off at any time. For radiation protection reasons, the X-ray inspection equipment frequently works with a limited radiation level. The useable beam of the X-ray system is focused by means of a collimator to a fan beam of only a few millimetres in width, which penetrates the test specimen placed on a conveyor belt from below. Detector diodes are mounted on the opposite side, and detect the energy of the fanned-out X-ray beam, and are scanned sequentially and rapidly by means of a PC. This establishes a scanned image, which can be analysed further and refined by means of image processing software. For the analysis and evaluation of the X-ray image, various tools and options are available. In general, automatic detection software (imaging software) is available, with which the image evaluation can be optimized. The image is preferably viewed using a monitor.

In order that the X-raying of autocatalysts in the metallic casings is enabled, the X-ray generator of the system should have an anode voltage in the range from 80 to 250 kV, preferably in the range from 100 to 180 kV. This ensures penetration which is high enough also to examine autocatalysts with a thick casing, especially those with a thick steel casing or cast iron casing. Furthermore, the X-ray beam must also penetrate the expanding mat. The use of specific image analysis methods also enables any dark regions which occur in the X-ray image to be lightened appropriately, in order to obtain additional information.

Typical values for the anode current are in the range from 0.1 to 1 mA. The X-radiation used in the process is generally insufficient to activate the X-rayed objects, and thus to contaminate them.

To perform the process according to the invention, the encased autocatalyst to be examined is placed onto the conveyor belt of the X-ray inspection system, passes through the X-ray beam in an inspection tunnel and is removed from the belt after the X-raying. The inspection tunnel of the X-ray inspection system suitable for the process should have dimensions in the range of about 100 cm×70 cm, preferably 80×60 cm, such that sufficiently large objects (possibly with flanges and manifolds) can be X-rayed. Typical operating temperatures are in the range from 10 to 50° C. The mean residence time for the X-raying of an autocatalyst is, according to size, in the range from 0.5 to 10 sec, preferably in the range from 1 to 5 sec. The residence time is continuously adjustable by a regulation of the belt speed of the conveyor belt. The belt speeds are typically in the range from 0.05 to 1 m/s.

Suitable X-ray inspection systems are commercially available. One example of a suitable X-ray inspection system is the HI-SCAN 150 MPI-700 (from Smiths-Heimann, Wiesbaden). However, other systems are also suitable for this purpose.

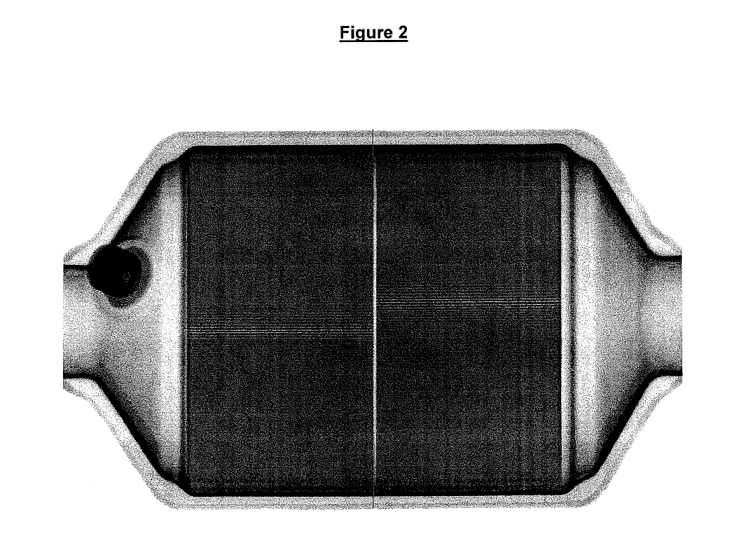

An X-ray image of an autocatalyst examined is shown by way of example in FIG. 2. The X-ray examination allows, for example, the following information for characterization of the autocatalyst to be obtained:
a) Dimensions of the support substrate: particular catalyst volume and weight can be calculated from the dimensions, and information about the noble metal content can be estimated. In addition, the type can be narrowed down.
b) Condition of the support substrate: damaged, destroyed or forged/manipulated monolithic catalyst supports are easily identifiable and can be eliminated.
c) Presence of metals, especially noble metals, in the catalytic coating: filling level and condition of the noble metal coating, presence of Pt, Pd and/or Rh.
d) Type of support substrate used: ceramic (cordierite, SiC), metal, etc.; cell density, coating type, structure, etc.
e) Catalyst type: particulate filter/three-way catalytic converter/diesel catalytic converter/NOx storage catalyst/SCR catalyst, etc.

The data obtained by X-ray inspection (step A) and optionally by further additional examination steps (steps A1-AX) are combined in step B of the process according to the invention with a data bank (“catalyst library”), evaluated manually or electronically and compared. The catalyst library contains, for example, information about dimensions, shape and special features of known, industrially manufactured coated support substrates and/or autocatalysts. This comparison can give an exact identification of the autocatalyst. This gives information which enables purchase at true value and/or material-oriented processing of the autocatalyst.

The data stored in the catalyst library relate generally to the fresh state or assembled state of a coated monolith. Ageing effects can be taken into account; the data then enable, when compared, a statement about the ageing condition of the test specimen. Therefore the process can also be employed for examination and diagnosis of automotive catalytic converters.

A further great advantage of the process according to the invention is the recognition of catalytic converter forgeries, which have recently started to occur frequently on the market. These are uncoated or manipulated encased catalytic converters, which are introduced into the recycling market with fraudulent intent.

Further configurations of the process are possible. As already described, the process according to the invention may also include processes for weighing, processes for measuring the electrical and/or magnetic properties and photographic processes. These additional processes may be used in sequential or parallel form to the X-ray inspection, and serve to further support, to refine and to confirm the information present.

The process according to the invention can be operated either batchwise or continuously, and is suitable for stationary and for mobile use. In addition, the process can be operated separately or can be integrated into an existing production line (for example into a recycling plant).

The present invention further provides an apparatus for identifying autocatalysts.

The invention comprises an apparatus for non-destructive identification of encased autocatalysts which comprise at least one metallic and/or ceramic support substrate, the surface of which may be provided with a catalytically active coating, said apparatus having
a) a device for X-ray inspection of the autocatalyst,
b) at least one device for comparing the data obtained with a data bank.

The device for X-raying the autocatalyst (X-ray inspection system) comprises an X-ray generator which is operated at an anode voltage in the range from 80 to 250 kV, preferably in the range from 100 to 180 kV.

The apparatus may also comprise devices for weighing, for measuring the electrical properties, for measuring the magnetic properties or for photographic imaging. A wide variety of different combinations of these additional devices are possible.

In the first device, encased autocatalysts are subjected to X-ray inspection. In a second device (e.g. an electronic analysis unit), the data determined from the X-ray inspection are compared with the previously stored and catalogued data for known, industrially manufactured autocatalyst systems (data bank/“catalyst library”). By a correlation with the values in this data bank, an exact identification of the autocatalyst is generally possible.

In the further embodiments of the process according to the invention, the apparatus suitable therefor, in addition to devices a) and b), may comprise further devices or modules for different examination processes: these are, for example, devices for weighing (e.g. balances), for measurement of the electrical and/or magnetic properties and for photographic imaging. Further devices are possible if required for more exact identification of the autocatalyst to be examined.

The inventive apparatus may be of modular structure; it may be operated either batchwise or continuously and is suitable for stationary or mobile use.

The process and apparatus may be used for purchasing and/or for sorting of autocatalysts, especially spent autocatalysts.

The examples which follow are intended to illustrate the invention in detail, but without restricting the scope of protection thereof.

### EXAMPLE 1

A steel-encased autocatalyst of unknown origin is examined with the HI-SCAN 150 MPI-700 X-ray inspection system (from Smiths-Heimann, Wiesbaden). The following system parameters were set:

| | | |
|---|---|---|
| Anode voltage: | 110 | kV |
| Anode current: | 0.5 | mA |
| Belt speed: | 0.25 | m/s |

The evaluation of the X-ray inspection gives information, inter alia, about the support substrate (here: ceramic, cordierite type), about the shape and the dimensions of the support substrate (here: cylindrical shape with particular diameter and length) and about the noble metals present (here: Pt, Pd and Rh present in particular proportions). The data obtained are compared electronically with a catalyst data bank (catalyst library) which contains information about commercially used coated support substrates and autocatalysts. This enables identification of the autocatalyst. After purchasing of the catalyst at true value, it is subsequently submitted to a suitable recycling process.

### EXAMPLE 2

A steel-encased autocatalyst of unknown origin is examined with the HI-SCAN 150 MPI-700 X-ray inspection system (from Smiths-Heimann, Wiesbaden). The system parameters are set according to Example 1. In addition, an electrical induction measurement is undertaken. The evaluation of the X-ray inspection and of the electrical induction measurement gives information, inter alia, about the support substrate (here: metal), about the support shape (here: cylindrical with particular dimensions) and about the noble metals present (here: Pt and Pd present in particular proportions). The data obtained are compared electronically with a catalyst data bank (catalyst library) which contains information about commercially used autocatalysts. An identification of the catalyst is carried out. After purchase of the catalyst at true value, it is subsequently submitted to a recycling process suitable for metal supports.

### EXAMPLE 3

An encased autocatalyst of unknown origin is examined with the HI-SCAN 150 MPI-700 X-ray inspection system (from Smiths-Heimann, Wiesbaden). The system parameters are set according to Example 1. The evaluation of the X-ray inspection gives information, inter alia, about the support substrate (here: ceramic, silicon carbide), about the support shape (here: cylindrical shape) and about the presence of noble metals (here: noble metals not present). The data obtained are compared electronically to a catalyst data bank (catalyst library) which contains information about commercially used autocatalysts. This is a noble metal-free soot particulate filter. After purchase at true value, it is submitted to a suitable recycling process.

1-16. (canceled)

17. A process for non-destructive identification of an encased autocatalyst which has at least one metallic and/or ceramic support substrate, the surface of which may be provided with a catalytically active coating, comprising:
a) X-ray inspection of the encased autocatalyst and collection of data for characterization of the support substrate; and
b) identifying the autocatalyst by comparing the data obtained with a data bank.

18. The process of claim 17, wherein the X-ray inspection in step a) is effected with an X-ray generator at an anode voltage in the range from 80 to 250 kV.

19. The process of claim 17, wherein the mean residence time for the X-raying in step a) is in the range from 0.5 to 10 sec.

20. The process of claim 17, wherein the data bank in step b) comprises data for known, industrially manufactured support substrates and/or autocatalysts, and the comparison is made by computer.

21. The process of claim 17, wherein the surface of the metallic or ceramic support substrate has a catalytically active coating which comprises at least one noble metal selected from the group consisting of Pt, Pd, Rh, Ir and combinations thereof.

22. The process of claim 17, wherein the data for characterization of the support substrate obtained in step a) comprise figures for the presence, type and/or amount of the noble metals selected from the group consisting of Pt, Pd, Rh and Ir.

23. The process of claim 17, further comprising a process step for measuring the electrical properties of the encased autocatalyst.

24. The process of claim 17, further comprising a process step for measuring the magnetic properties of the encased autocatalyst.

25. The process of claim 17, further comprising a process step for weighing the encased autocatalyst.

26. The process of claim 17, further comprising a process step for photographic imaging of the encased autocatalyst.

27. The process of claim 17, wherein the encased autocatalyst is an automotive exhaust gas catalytic converter or a particulate filter.

28. The process of claim 17, which is operated continuously.

29. An apparatus for non-destructive identification of an encased autocatalyst which comprises at least one metallic and/or ceramic support substrate, the surface of which may be provided with a catalytically active coating, said apparatus having
a) a device for X-ray inspection of the autocatalyst, and
b) at least one device for comparing the data obtained with a data bank.

30. The apparatus of claim 29, further comprising devices for weighing, and/or for measuring the electrical properties and/or for measuring the magnetic properties and/or for photographic imaging of the encased autocatalyst.

31. The apparatus of claim 29, wherein the device for X-raying the autocatalyst has an X-ray generator which is operated at an anode voltage in the range from 80 to 250 kV.

32. The process of claim 18, wherein the anode voltage is in the range from 100 to 180 kV.

33. The process of claim 28, which is integrated into a recycling plant.

34. The apparatus of claim 31, wherein the voltage is in the range from 100 to 180 kV.
